(19) United States
(12) Patent Application Publication
(10) Pub. No.: US 2024/0334251 A1
(43) Pub. Date: Oct. 3, 2024

(54) COORDINATED PERFORMANCE DEGRADATION OF AN ELECTRONIC DEVICE

(71) Applicant: MOTOROLA MOBILITY LLC, WILMINGTON, DE (US)

(72) Inventors: AMIT KUMAR AGRAWAL, BANGALORE (IN); BHASHYAM KRISHNAMA NAIDU SUKUMAR, BANGALORE (IN)

(21) Appl. No.: 18/191,392

(22) Filed: Mar. 28, 2023

(51) Int. Cl. H04W 28/18; G06F 21/74; H04W 52/02

(52) U.S. Cl. CPC H04W 28/18; G06F 21/74; H04W 52/0248

(57) ABSTRACT

An electronic device, a method and a computer program product for coordinated performance degradation of an electronic device. The method includes entering the device into a secondary user mode of operation via a processor on the electronic device, which includes a display, a memory storing at least one application and a control module for controlling the electronic device, and at least one processor communicatively coupled to the display and to the memory. The method includes generating, by the at least one processor, a quality-of-service (QoS) parameter reduction for at least one quality-of-service (QoS) parameter in response to the electronic device being in the secondary user mode of operation for a predetermined duration.

### BACKGROUND

### 1. Technical Field

The present disclosure generally relates to portable communication devices, and more specifically to communication devices that support usage by multiple users.

### 2. Description of the Related Art

Modern smartphones and tablet computers are equipped with high-resolution displays, as well as integrated digital cameras that capture high quality still pictures and videos. Smartphones, tablets, and other electronic devices can have benefits for children if used in a responsible and age-appropriate manner. A primary user, such as a parent, may sometimes allow a secondary user, such as a child to temporarily use his/her communication device (e.g., smartphone) to occupy the child, and allow the child to engage in activities via the communication device. These activities can include, but are not limited to, viewing video, listening to audio, playing games, using social media applications, and so on. Sometimes, when the primary user (e.g., parent) takes back the communication device, the secondary user (e.g., the child) can become upset and/or agitated. Excessive use of smartphones can have negative effects on children's development, including sleep disruption, decreased physical activity, and social isolation. Therefore, it is important to be cautious regarding smartphone use by children.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example component makeup of the communication device that can be configured to operate in a coordinated performance degradation mode, and within which various aspects of the disclosure can be implemented, according to one or more embodiments;

FIG. 2 is a diagram illustrating the user interface of an example communication device utilized to set the device into a secondary user mode of operation, according to one or more embodiments;

FIG. 3 is a graph illustrating examples of incremental reduction in quality-of-service (QoS) parameters, according to one or more embodiments;

FIG. 4 is a diagram illustrating an exemplary user experience during a coordinated reduction in quality-of-service (QoS) corresponding to slow download bandwidth, according to one or more embodiments;

FIG. 5 is a diagram illustrating another exemplary user experience during a coordinated reduction in quality-of-service (QoS) corresponding to reduction/depletion in battery power, according to one or more embodiments;

FIG. 6 is a diagram depicting various types of QoS parameter reductions that can be presented on the communication device when operating in the secondary user mode.

FIG. 7 depicts a flowchart of a method by which a communication device transitions between, and operates in, a secondary user mode of operation, according to one or more embodiments;

FIG. 8 depicts a flowchart of an additional method by which a communication device generates a QoS parameter reduction based on a ranking of the application(s) being utilized by the secondary user on the device, according to one or more embodiments;

FIG. 9 depicts a flowchart of an additional method by which a communication device transitions into, and operates in, a selected secondary user mode of operation, based on the specific secondary user from among multiple secondary users associated with the communication device, according to one or more embodiments.

### DETAILED DESCRIPTION

According to aspects of the disclosure, a communication device, a method, and a computer program product provide a coordinated performance degradation mode for the communication device. Specifically, the disclosure enables a primary user to establish a coordinated performance degradation mode for a communication device prior to temporarily giving the communication device to a secondary user. In one or more embodiments, the method includes entering a secondary user mode of operation for an electronic device having a display, a memory storing at least one application and a control module for controlling the electronic device, and at least one processor communicatively coupled to the display and to the memory. The method includes generating, by the at least one processor, a quality-of-service (QoS) parameter reduction for at least one quality-of-service (QoS) parameter in response to the electronic device being in the secondary user mode of operation for a predetermined duration.

According to one example, a primary user can be a parent, and the secondary user can be a child to whom the parent may occasionally provide temporary access to the parent's electronic device, such as a smartphone or tablet. However, the parent often wishes to restrict a child's usage of the electronic device. Restricting the usage when the child is still engaged with the device or after a short period of time may result in repulsive and obnoxious behaviors by the child who is not yet ready to relinquish access to the device. The present disclosure operates to reduce/minimize the amount of agitation and/or sadness of the secondary user due to having the communication device taken away from him/her. The disclosure accomplishes this feature via the coordinated performance degradation mode. In the coordinated performance degradation mode, one or more performance characteristics of the communication device is gradually and/or incrementally reduced, such that after some time, the secondary user (e.g., child) tires of using the communication device, and/or is lead to believe that the device is not functioning optimally and/or properly. In this way, the secondary user is encouraged on his/her own to voluntarily relinquish the communication device back to the primary user (e.g., parent) without the sadness and/or agitation that can often accompany such events.

According to aspects of disclosed embodiments, the communication device includes at least one display to render content, such as videos, game display, and/or other application user interfaces. The communication device also includes a memory having stored thereon a QoS reduction (QoSR) application with program code for incrementally and/or gradually reducing one or more QoS parameters during a usage period where the communication device is configured into a secondary mode of operation. The primary user may selectively activate the secondary mode of operation and then, the communication device may be provided to a secondary user. The QoS parameters can include, but are not limited to, a resolution of the display, a brightness of the display, and a size of a video window that is rendered on the display. The QoS parameter can further include other device features, such as remaining battery life, download or upload bandwidth/throughput, among others. The QoS parameter reductions can include, but are not limited to, decreasing a display resolution, decreasing a video resolution, decreasing a display brightness, decreasing an audio volume, decreasing network bandwidth and/or throughput, random playback pausing, inducing haptic delay, and/or other suitable QoS parameter reductions. As the QoS parameter(s) is/are reduced, the reduction adversely affects the user experience of the secondary user (e.g., child), which increases the likelihood that the secondary user voluntarily relinquishes the communication device back to the primary user (e.g., parent).

The communication device includes at least one processor communicatively coupled to the memory and the at least one display. The at least one processor processes program instructions of the QoSR application to configure the communication device to enter a secondary user mode of operation, and generate a quality-of-service parameter reduction for at least one quality-of-service (QoS) parameter, in response to the electronic device being in the secondary user mode of operation for a predetermined duration. The quality-of-service parameter reduction can be performed incrementally and/or gradually. In this way, the change is gradual, and the secondary user grows dissatisfied with the user experience, after some time, and stops using the communication device on his/her own, rather than only doing so upon request of the primary user.

In some embodiments, the at least one processor processes program instructions of the QoSR application to configure the communication device to cause random, momentary pauses in playback of a video that is rendered on the display. This can make the playback appear intermittent and/or ‘glitchy’ to the secondary user, causing him/her to tire of using the device, and return it to the primary user. The random pauses can increase in frequency over time. As an example, initially, the random pauses may occur at an average rate of once per minute. After some predetermined interval (e.g., 20 minutes), the average rate of random pauses can increase to twice per minute, and then to four times per minute, and so on, until the secondary user eventually deems the communication device to be unusable, and returns the device to the primary user.

In some embodiments, the communication device further includes a network interface communicatively coupled to the at least one processor and which enables the electronic device to connect to a network and download content being consumed at the electronic device. The at least one processor processes program instructions of the QoSR application to configure the communication device to induce an artificial network latency in the electronic device that negatively affects a consumption of the content. The artificial network latency can include intentional disabling of a hardware acceleration mode of packet transfer, modifying firewall rules, and/or otherwise intentionally delaying one or more incoming/or outgoing packets.

In some embodiments, the at least one processor processes program instructions of the QoSR application to configure the communication device to allow the primary user to establish a usage time for the secondary user. Once the communication device enters into the secondary user mode of operation, the communication device monitors a time remaining for the secondary user mode of operation. Additionally, or alternatively, in one or more embodiment, the communication device computes a false battery level (FBL), where the FBL is based on the time remaining and is less than an actual remaining battery level, and the device displays the FBL in place of the actual remaining battery level. As an example, the actual battery life may be at 90 percent, but the FBL may be shown as 40 percent. In some embodiments, the at least one processor processes program instructions of the QoSR application to configure the communication device to decrement the FBL at a periodic interval (e.g., reduce the FBL by 10 percent every 10 minutes). Once the FBL reaches zero, an empty charge value can be rendered on the display, and in response to the empty charge value, the at least one processor initiates a false shutdown mode of the device, including deactivating the display and other interface features of the electronic device. The false shutdown mode appears to the secondary user as a behavior in accordance with a battery that has insufficient charge to power the device. In one alternate embodiment, a notification of the low FBL can be generated and presented on the display or audibly outputted before or instead of the false shutdown so that the secondary user is made aware of the low battery level. The secondary user may thus be encouraged to return the communication device to be recharged before the battery “dies”.

In some embodiments, the at least one processor processes program instructions of the QoSR application to configure the communication device to monitor for entry of a biometric authentication input of a primary user, and the processor reactivates the display and return the electronic device to a primary user mode of operation in response to a biometric authentication of the primary user while the electronic device is in one of (i) a secondary user mode of operation or (ii) a false shutdown mode.

In some embodiments, the communication device further includes a communication subsystem that enables the electronic device to communicate with at least one second device via an external network, the communication subsystem communicatively coupled to the at least one processor. The at least one processor processes program instructions of the QoSR application to configure the communication device to receive, via the communication subsystem, a ranking for each application of a plurality of applications that are executable on the electronic device. The communication device sets a QoS reduction duration (QRD) for each application of the plurality of applications, based on a respective ranking. The rankings can enable application-specific QRD operation. As an example, a higher ranking can be correlated with a shorter duration of use. In such embodiments, a video game ranking may have a higher rank than an educational program. This allows the educational program to be used with less QoS reduction as compared with the video game, which may have increased QoS reduction, based on its higher rank. In one or more embodiments, the primary user may establish ranks for one or more applications that are resident on the communication device. One skilled in the art will appreciate that the above example is for illustration only and that the order of rankings may be the reverse of the presented example (i.e., higher ranking means less QoS reduction). Additionally, certain applications, such as a reading application, may be identified by the primary user to be outside of the consideration for a QoS reduction, where the primary user wishes to encourage as much usage of the particular application by the secondary user.

In some embodiments, the at least one processor processes program instructions of the QoSR application to configure the communication device to identify, based on one or more inputs, a secondary user from among a plurality of secondary users that each user has a corresponding secondary user identifier (ID) or secondary user profile and associated QoS parameter reduction profile. The communication device modifies at least one QoS reduction duration based on the identified secondary user. This enables the primary user to provide the device to a select one of multiple secondary users, each with a different set of QoS reduction durations that may be further differentiated by usage of specific applications. As an example, if a parent has two children, and a first child is 14 years of age, while a second child is 8 years of age, then the parent may wish to establish different QoS reduction durations based on who is using the communication device and what applications that secondary user is accessing/using. In some embodiments, the primary user may input, via a user interface, which one of the secondary users is using the device. The processor then configures the device to implement the QoS reductions associated with the identified user. In some embodiments, the secondary user may be automatically determined by the communication device via facial recognition, biometric identification, voice identification, and/or other suitable techniques.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, which enables the communication device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

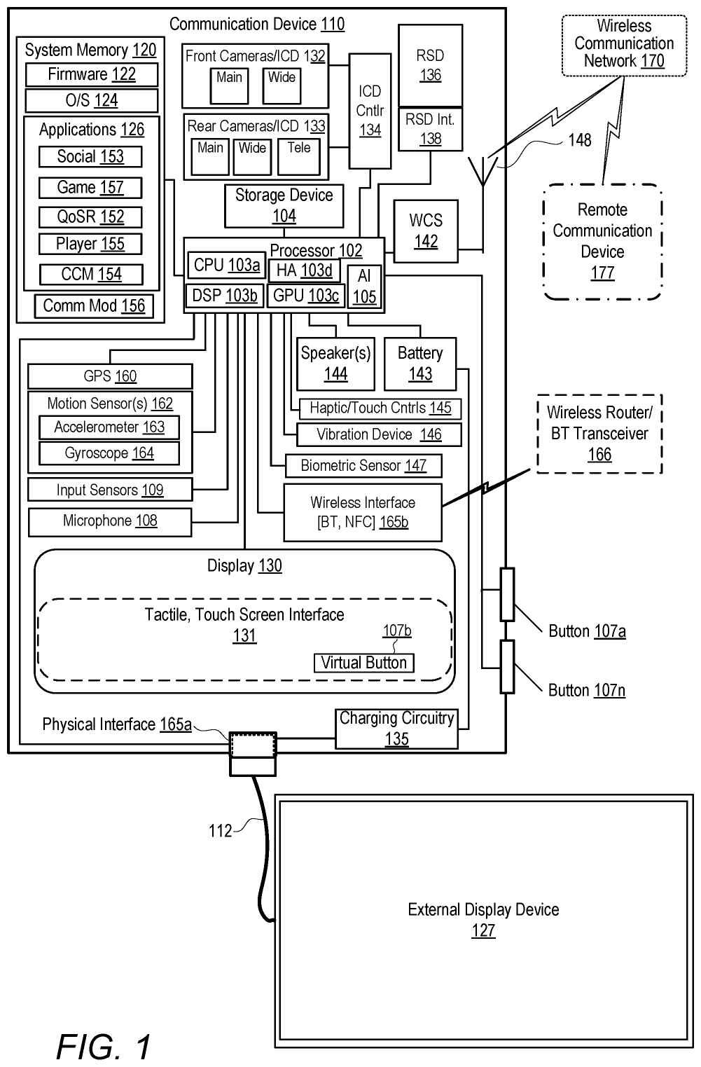

Those of ordinary skill in the art will appreciate that the hardware components and basic configuration depicted in the following figures may vary. For example, the illustrative components within communication device 110 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1, there is illustrated an example component makeup of communication device 110, with specific components used to enable the device to operate in a coordinated performance degradation mode, and within which various aspects of the disclosure can be implemented, according to one or more embodiments. Examples of communication device 110 include, but are not limited to, mobile devices, a notebook computer, a mobile phone, a smart phone, a digital camera with enhanced processing capabilities, a smart watch, a tablet computer, and other types of communication device that includes or can be directly connected to an image capturing device (ICD) (or camera) that captures video. It is appreciated that communication device 110 can be other types of communication devices that allow a primary user to configured the device for use by a secondary user in a QoS degraded state.

Communication device 110 includes processor 102 (typically as a part of a processor integrated circuit (IC) chip), which includes processor resources such as central processing unit (CPU) 103a, communication signal processing resources such as digital signal processor (DSP) 103b, graphics processing unit (GPU) 103c, and hardware acceleration (HA) unit 103d. Processor 102 can, in some embodiments, include high quality camera image signal processors (ISPs) (not shown) and dedicated artificial intelligence (AI) engines 105. Collectively, processor 102 supports computing, classifying, processing, transmitting and receiving of data and information, and presenting of graphical images within a display. Processor 102 is communicatively coupled to storage device 104, system memory 120, input devices (introduced below), output devices, including integrated display 130, and image capture device (ICD) controller 134. According to one or more embodiments, ICD controller 134 performs or supports functions such as, but not limited to, selecting and activating an active camera from among multiple cameras and adjusting the camera settings and characteristics (e.g., shutter speed, f/stop, ISO exposure, zoom control, field of view (FOV) angle, etc.) of the active camera. ICD controller 134 can perform these functions in response to commands received from processor 102, which processes instructions of camera control module 154 in order to control ICDs 132, 133 to capture video or still images of a local scene within a FOV of the operating/active ICD.

In one or more embodiments, the functionality of ICD controller 134 is incorporated within processor 102, eliminating the need for a separate ICD controller. Thus, for simplicity in describing the features presented herein, the various camera selection, activation, and configuration functions performed by the ICD controller 134 are described as being provided generally by processor 102. Similarly, manipulation of captured images and videos are typically performed by GPU 103c and certain aspects of device communication via wireless networks are performed by DSP 103b, with support from CPU 103a. However, for simplicity in describing the features of the disclosure, the functionality provided by one or more of CPU 103a, DSP 103b, GPU 103c, and ICD controller 134 are collectively described as being performed by processor 102.

Throughout the disclosure, the term image capturing device (ICD) is utilized interchangeably to be synonymous with and/or refer to any one of front or rear facing cameras 132, 133. Front facing cameras 132 and rear facing cameras 133 are communicatively coupled to ICD controller 134, which is communicatively coupled to processor 102. Both sets of cameras 132, 133 include image sensors that can capture images that are within the field of view (FOV) of the respective ICD 132. 133. Communication device 110 can include multiple cameras having different functionality, such as a main camera capturing standard view, wide angle camera that captures a wide angle FOV, and telephoto ICD, which captures a telephoto FOV (zoom or magnified). In one or more embodiments, a single camera can be provided with camera control options to change the single camera lens to allow for wide angle and telephoto image capture. In embodiments, one or more of the ICDs may be used for performing user identification via facial recognition.

System memory 120 may be a combination of volatile and non-volatile memory, such as random-access memory (RAM) and read-only memory (ROM). System memory 120 can store program code or similar data associated with firmware 122, an operating system 124, and/or applications 126. During device operation, processor 102 processes program code of the various applications, modules, OS, and firmware, that are stored in system memory 120.

In accordance with one or more embodiments, applications 126 include, without limitation, QoS reduction application (QoSR) 152, social media application 153, game application 157, media player application 155, camera control module 154, and communication module 156. Each module and/or application provides program instructions/code that are processed by processor 102 to cause processor 102 and/or other components of communication device 110 to perform specific operations, as described herein. Descriptive names assigned to these modules add no functionality and are provided solely to identify the underlying features performed by processing of the different modules. For example, QoSR 152 includes program instructions that support communication device 110 being configured to gradually and/or incrementally reduce one or more QoS parameters. Thus, in embodiments, QoSR 152 can serve as a secondary user mode control module for controlling the electronic communication device 110.

Communication module 156 within system memory 120 enables communication device 110 to communicate with wireless communication network 170 and with other devices, such as remote communication device 177, via one or more of audio, text, and video communications. Communication module 156 can support various communication sessions by communication device 110, such as audio communication sessions, video communication sessions, text communication sessions, exchange of data, and/or a combined audio/text/video/data communication session.

In one or more embodiments, communication device 110 includes removable storage device (RSD) 136, which is inserted into RSD interface 138 that is communicatively coupled via system interlink to processor 102. In one or more embodiments, RSD 136 is a non-transitory computer program product or computer readable storage device. RSD 136 may have a version of one or more of the applications (e.g., 152, 153, 154, 155, 157) stored thereon. Processor 102 can access RSD 136 to provision communication device 110 with program code that, when executed/processed by processor 102, the program code causes or configures processor 102 and/or generally communication device 110, to provide the various coordinated performance degradation functions described herein.

Communication device 110 includes an integrated display 130 which incorporates a tactile, touch screen interface 131 that can receive user tactile/touch input. As a touch screen device, integrated display 130 allows a user to provide input to or to control communication device 110 by touching features within the user interface presented on display screen. Tactile, touch screen interface 131 can be utilized as an input device. The touch screen interface 131 can include one or more virtual buttons, indicated generally as 107b. In embodiments, when a user applies a finger on the touch screen 131 in the region demarked by the virtual button 107b, the touch of the region causes the processor 102 to execute code to implement a function associated with the virtual button. In some implementations, integrated display 130 is integrated into a front surface of communication device 110, while the higher quality ICDs are located on a rear surface. As provided by the illustrative embodiment, communication device 110 can also include external display device 127, which is communicatively coupled to communication device 110 via a cable 112 attached to physical interface 165a, or by a wireless interface 165b. External display device 127 can be one of a wide variety of display screens, monitors, or devices, such as a liquid crystal display (LCD) and an organic light emitting diode (OLED) display.

Communication device 110 can further include microphone 108, one or more output devices such as speakers 144, and one or more input buttons 107a-107n. Microphone 108 can also be referred to as an audio input device. In some embodiments, microphone 108 may be used for identifying a user via voiceprint, voice recognition, and/or other suitable techniques. Input buttons 107a-107n may provide controls for volume, power, and ICDs 132, 133. Additionally, communication device 110 can include input sensors 109 (e.g., enabling gesture detection by a user).

Communication device 110 further includes haptic touch controls 145, vibration device 146, fingerprint/biometric sensor (or biometric input mechanism) 147, global positioning system (GPS) device 160, and motion sensor(s) 162. Vibration device 146 can cause communication device 110 to vibrate or shake when activated. Vibration device 146 can be activated during an incoming call or message in order to provide an alert or notification to a user of communication device 110. In one or more embodiments, vibration device 146 can be used as an alert when presenting a notification to a secondary user of a false depleted status of the battery. According to one aspect of the disclosure, integrated display 130, speakers 144, and vibration device 146 can generally and collectively be referred to as output devices.

Biometric sensor 147 can be used to read/receive biometric data, such as fingerprints, to identify or authenticate a user, and in some embodiments, the biometric sensor 147 can supplement an ICD (camera) for secondary user detection/identification. In one or more embodiments, biometric sensor 147 can be utilized, in addition to or independent of the image sensor, to separately identify the primary user and the secondary user of the communication device in order to activate device operation in either a primary user mode or a secondary user mode, respectively.

GPS device 160 can provide time data and location data about the physical location of communication device 110 using geospatial input received from GPS satellites. Motion sensor(s) 162 can include one or more accelerometers 163 and gyroscope 164. Motion sensor(s) 162 can detect movement of communication device 110 and provide motion data to processor 102 indicating the spatial orientation and movement of communication device 110. Accelerometers 163 measure linear acceleration of movement of communication device 110 in multiple axes (X, Y and Z). Gyroscope 164 measures rotation or angular rotational velocity of communication device 110. In one or more embodiments, the measurements of these various sensors can also be utilized by processor 102 in the determining if the device is currently being used by a secondary user. Communication device 110 further includes a housing that contains/protects the components internal to communication device 110.

Communication device 110 further includes wireless communication subsystem (WCS) 142, which can represent one or more front end devices (not shown) that are each coupled to one or more antennas 148. In one or more embodiments, WCS 142 can include a communication module with one or more baseband processors or digital signal processors, one or more modems, and a radio frequency (RF) front end having one or more transmitters and one or more receivers. WCS 142 and antennas 148 allow communication device 110 to communicate wirelessly with a wireless communication network 170 via transmissions of communication signals to and from network communication devices, such as base stations or cellular nodes, of wireless communication network 170.

Wireless communication network 170 further allows communication device 110 to wirelessly communicate with remote communication device 177, which can be similarly connected to wireless communication network 170. Communication device 110 can also communicate wirelessly with wireless communication network 170 via communication signals transmitted by short range communication device(s) to and from an external transceiver device, such as WiFi router 166, which is communicatively connected to wireless communication network 170. In one or more embodiments, wireless communication network 170 can be interconnected with a wide area network that can include one or more devices that support exchange of audio and video messages, data, and/or other communication between communication device 110 and remote communication device 177.

Wireless interface 165b can be a short-range wireless communication component providing Bluetooth, near field communication (NFC), and/or wireless fidelity (Wi-Fi) connections. In one embodiment, communication device 110 can receive Internet or Wi-Fi based calls via wireless interface 165b. In one embodiment, communication device 110 can communicate wirelessly with external wireless transceiver device 166, such as a WiFi router or BT transceiver, via wireless interface 165b. In an embodiment, WCS 142, antenna(s) 148, and wireless interface 165b collectively provide communication interface(s) of communication device 110. For session-based network traffic, the hardware acceleration (HA) unit 103d may establish direct memory access (DMA) sessions to route traffic to various elements within communication device 110 without direct involvement from processor 102 and/or operating system 124.

Communication device 110 also includes a physical interface 165a. Physical interface 165a of communication device 110 can serve as a data port and can be coupled to charging circuitry 135 and device battery 143 to enable recharging of device battery 143.

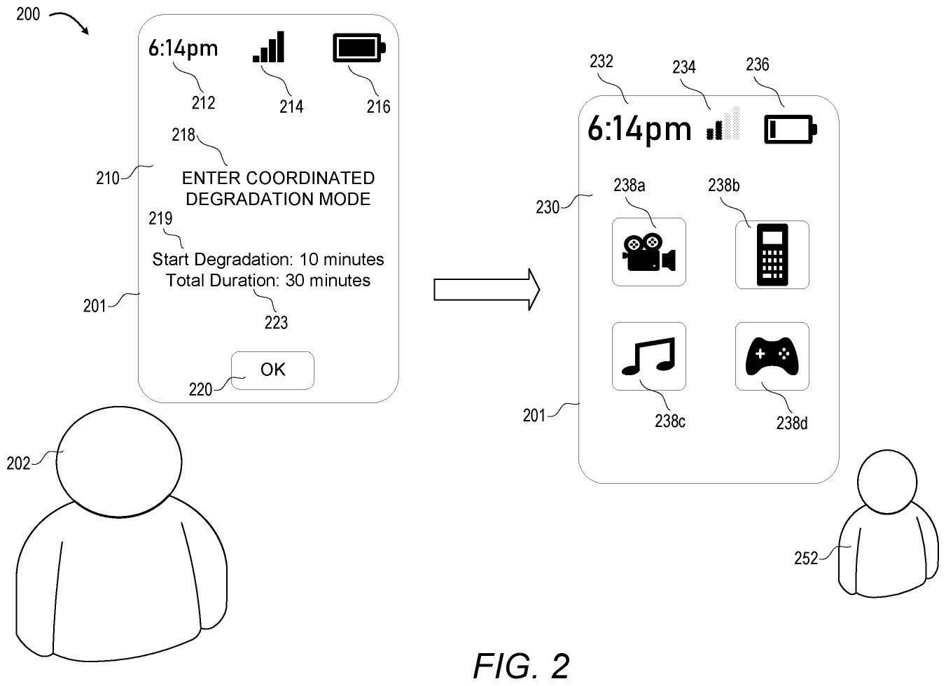

FIG. 2 is a diagram 200 illustrating the user interface of an example communication device utilized to set the device into a secondary user mode of operation, according to one or more embodiments. In an exemplary usage, a primary user 202 is configuring a communication device 201. Communication device 201 can be an implementation of communication device 110 (FIG. 1) having the same or similar components and providing the same or similar functions as communication device 110. The communication device 201, during configuration by the primary user 202. presents a user interface indicated at 210. The user interface 210 can include various elements such as a time indication 212, a signal strength indication 214, and/or a battery level indication 216. The user interface 210 may also include a field 218 displaying instructions for placing the communication device 201 in a secondary user mode of operation. The user interface 210 may also include a field 219 for establishing a time limit for when to start reduction of at least one QoS parameter, and a field 223 for establishing a duration for the secondary user mode of operation. The user interface may include a button 220, which when invoked, causes the at least one processor (e.g., processor 102) to transition the communication device 201 into the secondary user mode of operation (coordinated degradation mode). It is appreciated that the normal mode of operation is synonymous with or may be referred to as a primary user mode of operation, and that the communication device transitions into the secondary mode of operation from the normal (or primary user) mode of operation.

Once the communication device 201 is in the secondary user mode of operation, the primary user 202 may provide the communication device 201 to a secondary user 252. In some use cases, the secondary user 252 may be a child, and the primary user 202 may be a parent and/or caregiver for the child. The communication device 201, once placed into the secondary user mode of operation, presents a second user interface indicated at 230. The second user interface 230 can include a time indication 232. The time indication 232 may function similarly to time indication 212 in user interface 210. The second user interface 230 can include a signal strength indication 234. The signal strength indication 234 can differ from the signal strength indication 214 of user interface 210. As shown in diagram 200, the signal strength indication 234 indicates a weaker signal than signal strength indication 214. This feature can be part of the secondary user mode of operation, to provide the appearance of a weaker signal, which can add plausibility to QoS reductions. The signal strength indications can indicate strength of a cellular signal, WiFi signal, or other suitable signal.

The second user interface 230 can include a battery level indication 236. The battery level indication 236 of second user interface 230 can differ from the battery level indication 216 of user interface 210. As shown in diagram 200, the battery level indication 236 indicates a lower battery level than battery level indication 216. Battery level indication 216 is indicative of an actual remaining battery level, while battery level indication 236 indicates a false battery level (FBL). This feature can be part of the secondary user mode of operation, to provide the appearance of a shorter remaining battery charge, which can add plausibility to QoS reductions.

The second user interface 230 can include one or more icons for various applications, indicated generally as 238a-238d. The secondary user 252 uses the communication device 201 in a secondary user mode of operation. As usage progresses, disclosed embodiments gradually and/or incrementally reduce one or more QoS parameters, gradually creating an increasingly poor user experience for the secondary user 252, increasing the likelihood that the secondary user 252 voluntarily stops usage of the communication device 201.

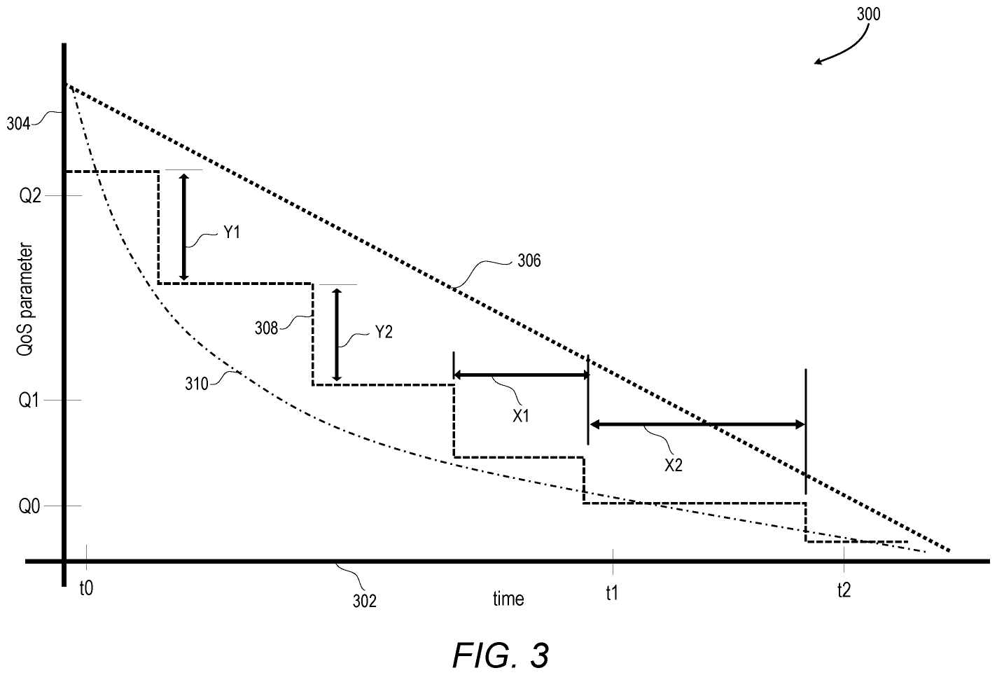

FIG. 3 is a graph 300 illustrating examples of incremental reduction in quality-of-service (QoS) parameters, according to one or more embodiments. Graph 300 includes a horizontal axis 302, representing time. On the horizontal axis 302, time t0 indicates an initial time. Time t1 indicates a point in time after time t0. Similarly, time t2 indicates a point in time after time t1. Graph 300 further includes a vertical axis 304. The vertical axis 304 indicates a level of a QoS parameter, with higher levels indicating a higher QoS level. Thus, Q2 indicates a high QoS level, and Q1 indicates a lower QoS level as compared with Q2, and Q0 indicates a lower QoS level than Q1. The lower QoS levels generally result in a poorer user experience than higher QoS levels. The QoS parameter depicted in graph 300 can include a wide variety of parameters, including, but not limited to, display brightness, display resolution, video window resolution, audio volume level, audio frequency range, network latency, haptic latency, battery charge level, and/or other QoS parameters. Line 306 indicates a linear QoS degradation. As time continues, the QoS parameter reduces linearly as a function of time. Line 308 indicates a stepwise QoS degradation, whereby, as time continues, the QoS parameter reduces in discrete increments. As an example, reduction amounts in QoS are shown at Y1 and Y2. In some embodiments, Y1 may equal Y2. In other embodiments, Y1 may be unequal to Y2. In some embodiments, the reduction amounts may increase as a function of time, giving the appearance of progressively reduced performance of the communication device. Exemplary durations of a given step are shown at X1 and X2. In some embodiments, X1 may equal X2. In other embodiments, X1 may be unequal to X2. In some embodiments, the step duration may change as a function of time. Line 310 indicates a non-linear QoS degradation. In some embodiments the non-linear QoS degradation is based on a polynomial function. The polynomial function can be selected to mimic actual degradation, such as decreased display brightness as a function of battery life. Other embodiments may utilize other QoS degradation functions.

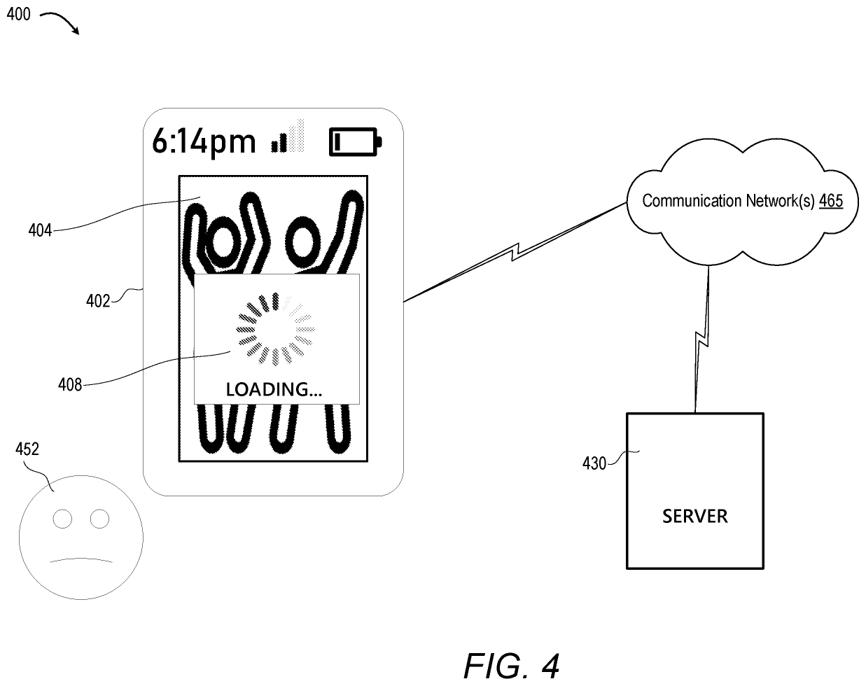

FIG. 4 is a diagram 400 illustrating an exemplary user experience during a reduction in quality-of-service (QOS) corresponding to a false download latency, according to one or more embodiments. A secondary user 452 is using communication device 402 to view a video 404 that is being downloaded or streamed from communication network 465. The communication device 402 connects to server 430 via communication network(s) 465. Communication network(s) 465 can include the Internet, a local area network (LAN), wide area network (WAN), and/or other suitable networks. Server 430 can include a video server. The video server may utilize one or more protocols, including but not limited to, Hypertext Transfer Protocol (HTTP), Real-time Transport Protocol (RTP), Real Time Streaming Protocol (RTSP), and/or other protocols to stream video content to communication device 402. The video content can be in a variety of formats, including, but not limited to, HTTP Live Streaming (HLS), Web Real-Time Communications (WebRTC), Dynamic Adaptive Streaming over HTTP (MPEG-DASH), MPEG-4, H.263, H.264, and/or other suitable formats and/or combinations thereof. As part of a coordinated performance degradation of communication device 402, network latency may be automatically induced by processor of communication device 402, causing the video playback application to render a buffering indication 408. The network latency may be introduced by pausing and/or discarding of incoming data, altering firewall configurations on the communication device, altering a hardware acceleration mode of the communication device, and/or other suitable techniques. In this way, the secondary user 452 is likely to grow dissatisfied with the user experience regarding video playback on the communication device 402 of the downloaded content from server 430, and the secondary user 452 is therefore more likely to be willing to relinquish the communication device 402 back to the primary user and/or voluntarily return the communication device 402 to the primary user. In some scenarios, this voluntary return of the device 402 to the primary user can alleviating potential sadness and/or agitation of the secondary user 452 that can occur when the secondary user is otherwise asked to relinquish the communication device 402.

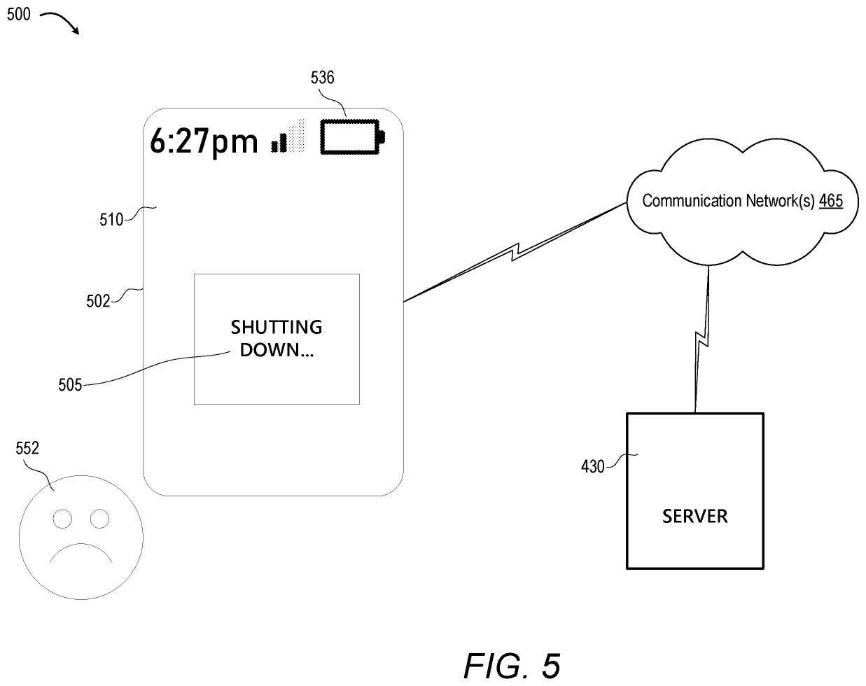

FIG. 5 is a diagram 500 illustrating another exemplary user experience during a reduction in quality-of-service (QoS) corresponding to remaining battery power, according to one or more embodiments. A secondary user 552 is using communication device 502, which could be connected to server 430 via communication network(s) 465 as described for FIG. 4. In one or more embodiments, the communication device 502 could be used for gaming and/or other purposes. In some use cases, the communication device 502 could be operating in an offline mode, in which it is not connected to communication network(s) 465.

As part of a coordinated performance degradation of communication device 502, a false shutdown mode may be initiated. An empty charge value 536 may be indicated by a false battery level indication. In one or more embodiments, in response to an empty charge value being rendered on the display, a false shutdown mode is initiated. Initiating the false shutdown mode can include rendering a user interface 510 on the communication device 502. The user interface 510 can include a field 505 indicating an impending shutdown of the communication device 502. After a predetermined interval, the display of the communication device 502 may be deactivated, and in some embodiments, buttons of the device (e.g., 107a-107n of FIG. 1) may also be deactivated to give the impression that the communication device is powered off. In some embodiments, during the false shutdown mode, the communication device is actually placed in a standby mode, where the processor (102 of FIG. 1) and numerous other components such as cameras, microphones, and/or biometric sensors, are still powered on and operational. In some embodiments, the communication device includes at least one user authentication input mechanism, which can include biometric sensors 147. Additional examples of biometric sensors 147 can include imaging sensors (132/133), audio input sensors (108), and fingerprint scanner (147) of FIG. 1), and the at least one processor monitors for entry of a user authentication input of a primary user. Upon a successful user authentication, the at least one processor reactivates the display (if the display has been turned off while the device was in the secondary user mode) and/or returns the electronic device to a primary user mode of operation. In some embodiments, facial recognition, voice recognition, grip detection, and/or other biometric authentication techniques are used by the processor to confirm that the primary user has taken possession of the communication device, and the processor transitions the communication device from a secondary user mode of operation or a false shutdown mode to a primary user mode of operation. The primary user mode of operation is a mode of operation in which the coordinated performance degradation is disabled.

Accordingly, the secondary user 552, upon experiencing the false shutdown mode, is more likely to be willing to relinquish the communication device 502 back to the primary user and/or voluntarily return the communication device 502 to the primary user. This voluntary return of the communication device 502 can alleviate potential sadness and/or agitation of the secondary user 552 that can occur when the secondary user is asked to relinquish the communications device 502.

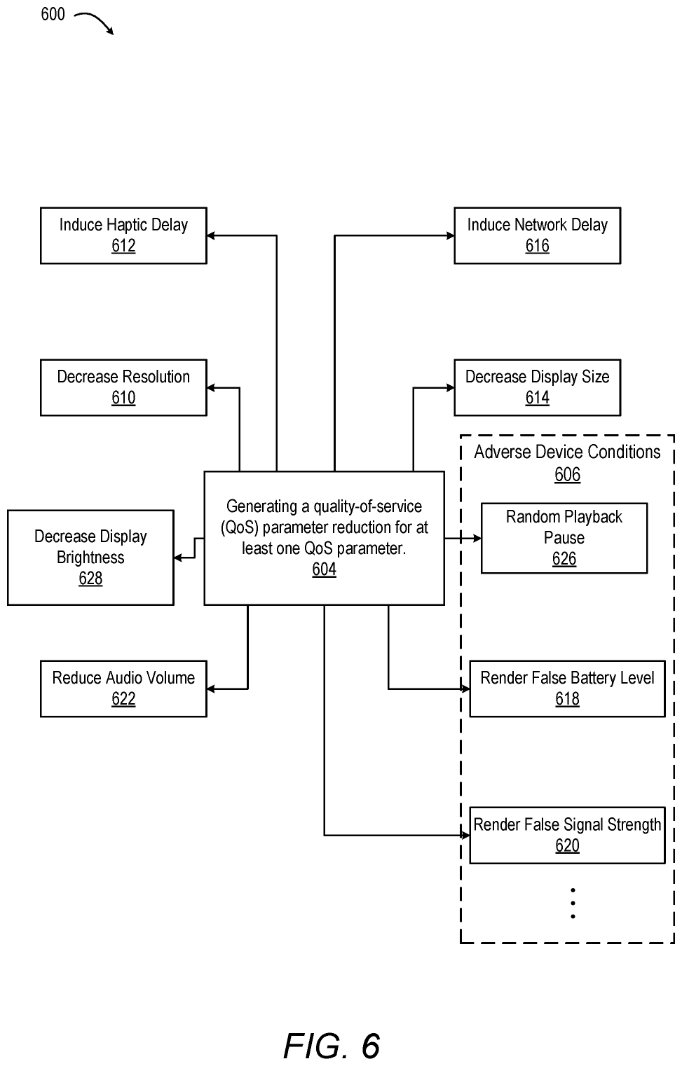

FIG. 6 is a diagram 600 depicting the various types of QoS parameter reductions that can be presented on the communication device when operating in the secondary user mode, according to one or more embodiments. The process(es) presented within diagram 600 starts at block 604, which includes the processor of the communication device generating quality-of-service (QoS) reduction of at least one QoS parameter. In embodiments, more than one QoS parameter may be reduced concurrently. Additionally, in one or more embodiments, different ones of the QoS parameters can be reduced in different scenarios, such as (i) for different secondary users, (ii) within differently configured communication devices, (iii) at different times of the day, (iv) at different detected locations of device usage, etc. From block 604, the device processor can generate QoS reduction by decreasing resolution at block 610. The resolution that is reduced can be the resolution of the entire display, or the resolution of an active video window within the display. The device processor can generate QoS reduction by decreasing a display brightness at block 628. The device processor can generate QoS reduction by decreasing a display size at block 614. The device processor can generate QoS reduction by inducing a haptic delay at block 612. In some embodiments, a haptic response is generated for user input actions such as button presses, swipes, taps, double taps, and the like. In one or more embodiments, this functionality is provided by haptic/touch controls 145 and/or vibration device 146 as shown in FIG. 1. With an induced haptic delay, the ‘clicks’ that are felt a by a user as he/she presses a virtual button are delayed on the order of hundreds of milliseconds from when the virtual button was pressed. This gives the impression of a ‘laggy’ user interface that may cause the secondary user to stop using the device.

The device processor can generate QoS reduction by inducing a network delay at block 616. In one or more embodiments, the network delay can include delaying one or more incoming or outgoing packets. The network delay can include reconfiguring a firewall within the operating system (124 of FIG. 1) to limit bursts of data, and/or block or throttle traffic to or from specific addresses. The network delay can cause an adverse user experience for any network-enabled activities such as streaming videos, playing online games, using online video conferencing, and the like. The device processor can generate QoS reduction by reducing audio volume at block 622. This can include reducing audio volume from built-in speaker(s) 144 of FIG. 1, and/or headphones connected via physical interface 165a and/or via Bluetooth, coupled to wireless transceiver device 166 (FIG. 1).

The device processor can generate QoS reduction by performing one or more actions to create a false sense of adverse device conditions. The adverse device conditions 606 can include rendering a false battery level at block 618. The false battery level is intended to make a secondary user think that the battery level of an electronic device is lower than the battery level actually is. In this way, the secondary user may be inclined to stop using the electronic communication device upon observing a false battery level indication, such as shown at 236 of FIG. 2. The adverse device conditions 606 can include rendering a false signal strength indication at block 620. The false signal strength indication is intended to make a secondary user think that the received signal strength by the electronic device is weaker than the signal actually is. In this way, the secondary user may be inclined to stop using the electronic communication device upon observing a false signal strength indication, such as shown at 234 of FIG. 2. The adverse device conditions 606 can include a random playback pause at block 626. The random playback pause is intended to make a secondary user think that media being rendered by the electronic device is ‘glitchy’ and is not being decoded and/or rendered well. In this way, the secondary user may be inclined to stop using the electronic communication device upon repeated random playback pauses. It is appreciated that most or all of the QoS reductions can be considered by the secondary user as an adverse device condition 606.

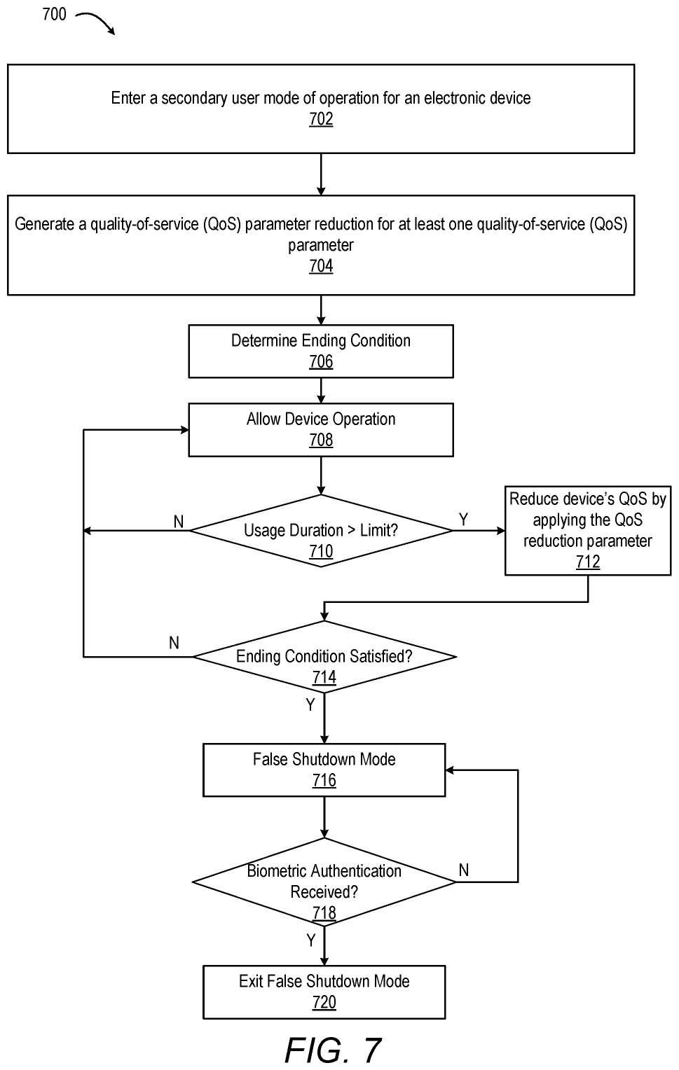

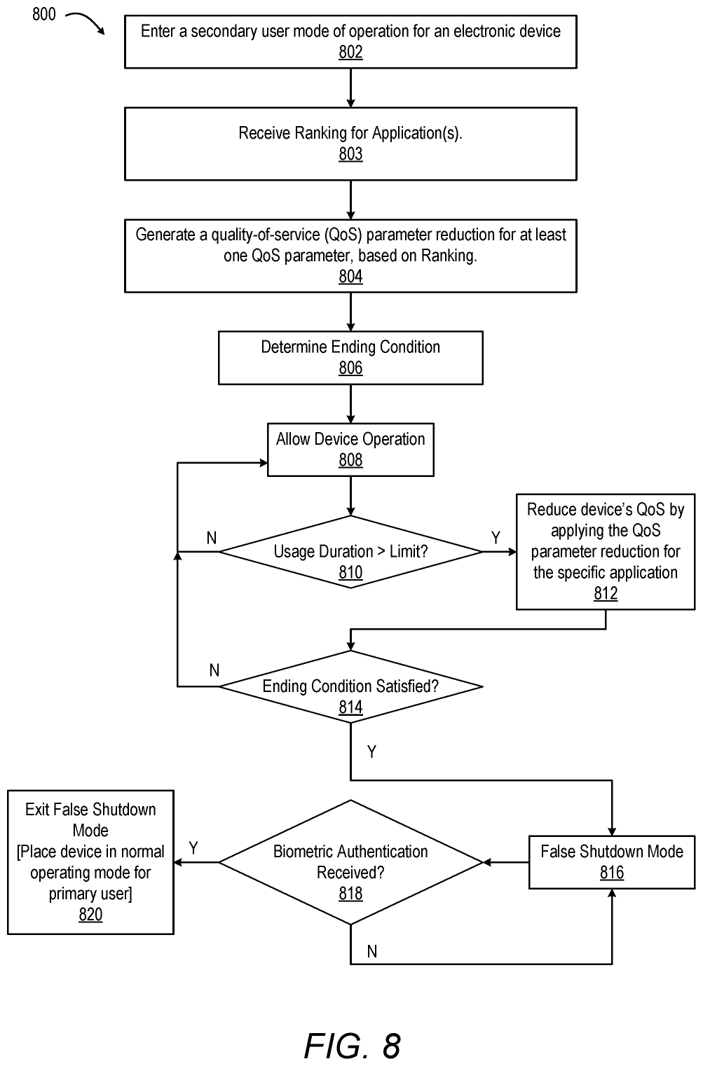

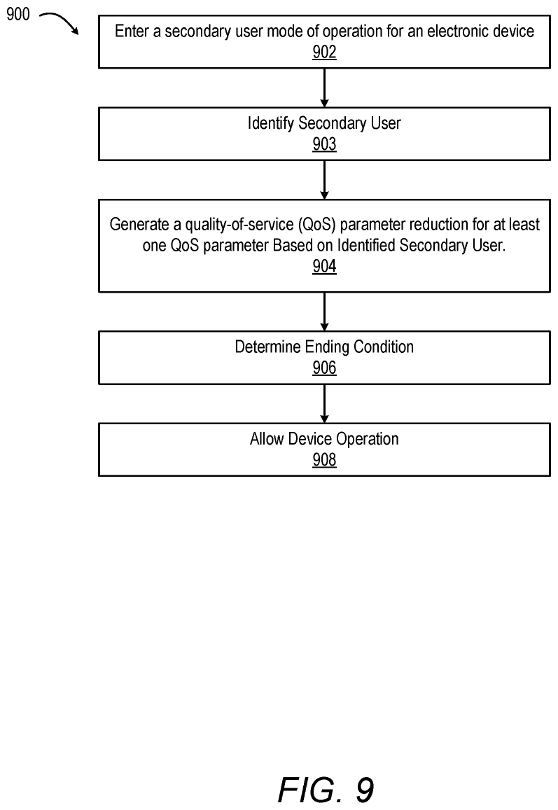

Referring now to the flow charts, FIG. 7 is a flow diagram presenting an of a method 700 by which a communication device transitions to, and operates in, a secondary user mode of operation. FIG. 8 depicts a flowchart of a method 800 by which a communication device is configured to operate in, and operates in, a secondary user mode of operation, based on a ranking of the application(s) being utilized by the secondary user, according to one or more embodiments. FIG. 9 depicts a flowchart of an additional method 900 by which a communication device transitions into, and operates in, a selected secondary user mode of operation, based on the specific secondary user from among multiple secondary users associated with the communication device. according to one or more embodiments. The descriptions of method 700 (FIG. 7), method 800 (FIG. 8), and method 900 (FIG. 9) are provided with general reference to the specific components illustrated within the preceding FIGS. 1 and 2 and other features illustrated within one of more of FIGS. 3-6. Specific components referenced in method 700 (FIG. 7), method 800 (FIG. 8), method 900 (FIG. 9) may be identical or similar to components of the same name used in describing preceding FIGS. 1 and 2. In one or more embodiments. processor 102 (FIG. 1) configures communication device 110 (FIG. 1) to provide the described functionality of method 700 (FIG. 7), method 800 (FIG. 8), method 900 (FIG. 9) by executing program code for one or more modules or applications provided within system memory 120 of communication device 110.

FIG. 7 depicts a flowchart of a method 700 by which a communication device transitions to, and operates in, a secondary user mode of operation, according to one or more embodiments. The method 700 begins at block 702 at which the method includes entering a secondary user mode of operation for an electronic device. In one or more embodiments. setting/selecting the device to enter a secondary user mode is performed by a primary user's interaction with a user interface, such user interface 210 (FIG. 2), via a touchscreen, utilizing a combination of button presses, taps, double taps, swipes, and the like. In some embodiments, other techniques, such as gesture recognition, voice commands, and/or other techniques may be used for placing the communication device into the secondary user mode of operation. Method 700 includes, at block 704, generating a quality-of-service (QoS) parameter reduction for at least one quality-of-service (QoS) parameter that can be applied when the communication device is in secondary user mode of operation for a predetermined duration. In one or more embodiments, the QoS parameter can include, but is not limited to, display resolution, display brightness, audio volume, haptic latency, network latency, and/or other QoS parameters. In one or more embodiments, the QoS parameter reduction can be linear, stepwise, or nonlinear, such as depicted in graph 300 of FIG. 3. Method 700 can include determining an ending condition at block 706. In embodiments, the ending condition can include a time duration that is specified by the primary user, such as at field 223 shown in FIG. 2. In some embodiments, the ending condition can include a location, such as determined by an onboard GPS (160 of FIG. 1). In some embodiments, the ending condition is satisfied in response to the secondary user travelling more than a predetermined distance from a specified location. In an example use case, if a secondary user leaves his/her neighborhood, the ending condition can be satisfied. In another example user case, the ending condition is satisfied whenever the device is geo-located at a specific address, such as at home or at the primary user's business office. In some embodiments, the ending condition can include motion activity, such as determined by motion sensor(s) (162 of FIG. 1). In some embodiments, the ending condition is satisfied in response to motion exceeding a predetermined threshold. The motion can be indicative of the secondary user being rough or careless with the communication device. In an example use case, if a secondary user is shaking the communication device or throwing it, the corresponding acceleration is detected by the motion sensors, and the increase in acceleration can trigger the ending condition.

The method continues to block 708, which includes enabling device operation in the secondary mode of operation. The method continues to block 710 where a check is made to determine if a usage duration exceeds a predetermined limit. In one or more embodiments, the predetermined limit is established by the primary user, such as shown at field 219 in FIG. 2. If the usage duration does not exceed the predetermined limit at block 710, then the method returns to block 708 to continue allowing device operation. If the usage duration does exceed the predetermined limit at block 710, then the method continues to block 712, where at least one QoS parameter is reduced in response to the communication device being in the secondary user mode of operation for a predetermined duration. The QoS parameter is reduced by applying the QoS parameter reduction generated for the device when the device is being utilized by the secondary user. Reducing a QoS parameter reduces performance of the communication device and degrades the user experience. The method continues to 716 where a check is made to determine if the ending condition is satisfied. If the ending condition is not satisfied at block 714, then the method returns to block 708 to continue allowing operation of the (electronic) communication device. If the ending condition is satisfied at block 714, then the method continues to 716, where a false shutdown mode is initiated, such as depicted in FIG. 5. Once in false shutdown mode, the method continues to block 718, where a check is made to determine if a biometric authentication from a primary user is received. If a valid biometric authentication is not received at block 718, the method returns to block 716 and the communication device remains in false shutdown mode. If a valid biometric authentication is received at block 718, the method continues to block 720, where the device exits false shutdown mode, and returns to a primary mode of operation.

FIG. 8 depicts a flowchart of a method 800 by which a communication device is configured to operate in, and operates in, a secondary user mode of operation, based on a ranking of the application(s) being utilized by the secondary user, according to one or more embodiments. The method 800 begins at block 802 at which the method includes entering a secondary user mode of operation for an electronic device. In embodiments, the entering a secondary user mode is performed via interaction by a primary user with a user interface such as a touchscreen, utilizing a combination of button presses, taps, double taps, swipes, and the like, such as indicated in user interface 210 (FIG. 2). In some embodiments, other techniques, such as gesture recognition, voice command, and/or other techniques may be used for placing the communication device into the secondary user mode of operation. Method 800 includes, at block 803, receiving a ranking for one or more applications. The rankings can be based on an effect rating, which is an indication of how much a particular application has positive or negative effects on user(s) of the application. In one or more implementations, the highest ranking may be associated with a larger negative effect, while a lowest ranking may be associated with a larger positive effect. The ranking can be received from an online source, such as an online application marketplace, and/or another ranking source, such as a third-party ranking source to which the communication device is communicatively connected by the communications subsystem. In some embodiments, the primary user may be able to edit/change/create a ranking for an application. In one or more implementations, the highest ranking may be associated with a larger negative effect, while a lowest ranking may be associated with a larger positive effect. As an example, a highest ranking may be assigned to applications such as social media applications, certain video games, and so on. Conversely, a lowest ranking may be assigned to educational and/or academic applications. Method 800 is described using this ranking scheme; However, in one or more alternate implementations, an inverse ranking scheme may be utilized. Method 800 includes, at block 804, generating a quality-of-service (QoS) parameter reduction for at least one QoS parameter based on the ranking obtained at block 803. In this way, the different applications can exhibit different levels of QoS degradation. In an example use case, a social media application, having a highest ranking associated with applications rated as producing a negative effect, may be configured to start degrading in 10 minutes and to initiate false shutdown mode in 30 minutes, while an educational application may be configured to start degrading in 60 minutes, and to initiate false shutdown mode in 120 minutes. Method 800 can include determining an ending condition at block 806. In embodiments, the ending condition can include a time duration that is specified by the primary user, such as at field 223 shown in FIG. 2. In some embodiments, the ending condition can include a location, such as determined by an onboard GPS (160 of FIG. 1).

In one or more embodiments, the processor may enable a primary user to establish a priority for identifying an end condition. As an example, when a primary user is travelling to a location, it can be desirable to keep the secondary user (e.g., child) occupied while the primary user (e.g., parent) is driving. In one or more embodiments, if usage time expires before the electronic device arrives at a specified location, the location parameter takes precedence, and a false shutdown may be deferred until the specified location is reached. In one or more embodiments, the primary user can prioritize the behavior of the shutdown behavior based on a priority (e.g., time elapsed, location information, etc.).

The method continues to block 808, where device operation in the secondary mode of operation is allowed. The method continues to block 810 where a check is made to determine if a usage duration exceeds a predetermined limit. If at block 810, the usage duration has not exceeded the predetermined limit, then the method returns to block 808 to continue allowing device operation. If the usage duration has exceeded the predetermined limit at block 810, then the method continues to block 812, where at least one QoS parameter is reduced by applying the QoS parameter reduction for the specific application being utilized by the secondary user. The method continues to block 816 where a check is made to determine if the ending condition is reached/satisfied. If the ending condition is not reached/satisfied at block 814, the method returns to block 808 to continue allowing operation of the (electronic) communication device. If the ending condition is reached/satisfied at block 814, then the method continues to block 816, where a false shutdown mode is initiated, such as depicted in FIG. 5. Once in false shutdown mode, the method continues to block 818, where a check is made to determine if a biometric authentication from a primary user is received. If at block 818, a valid biometric authentication is not received, then the method returns to block 816 and the communication device remains in false shutdown mode. If at block 818, a valid biometric authentication is received, then the method continues to block 820, where the device exits false shutdown mode, and returns to a primary mode of operation (i.e., the normal operating mode for the primary user).

FIG. 9 depicts a flowchart of an additional method 900 by which a communication device transitions into, and operates in, a selected secondary user mode of operation, based on the specific secondary user from among multiple secondary users associated with the communication device, according to one or more embodiments. The method 900 begins at block 902 at which the method includes entering a secondary user mode of operation for an electronic device, as previously described. Method 900 includes, at block 903, identifying a secondary user by receiving a user identifier (ID), secondary user passcode to access the device, or using detected/sensed/received user biometrics. The specific type and duration of QoS parameter reduction(s) can be based on the secondary user, particularly where there are multiple secondary users that utilized the same device. As an example, a primary user may have multiple children that vary in age. The primary user may wish to allow older children to use the device for longer periods, while younger children get less time to use the device before QoS parameter reduction starts. Method 900 includes, at block 904, generating a quality-of-service (QoS) parameter reduction for at least one QoS parameter based on the identified secondary user. Accordingly, the electronic device can provide different secondary users with different levels of QoS degradation. In an example use case, a user identifier associated with an 8-year-old secondary user can cause the communication device to be configured to start degrading in 10 minutes and to initiate false shutdown mode in 30 minutes, while a user identifier associated with a 14-year-old secondary user can cause the communication device to be configured to start degrading in 60 minutes, and to initiate false shutdown mode in 120 minutes. Method 900 can include determining an ending condition at block 906. In embodiments, the ending condition can include a time duration that is specified by the primary user, such as at field 223 shown in FIG. 2. In some embodiments, the ending condition can include a location, such as determined by an onboard GPS (160 of FIG. 1).

The method continues to block 908, where device operation in the secondary mode of operation is allowed with specific device operating conditions and QoS reduction processes implemented, based on the identified user. The method can then proceed until the end of the time allotted for the particular secondary user. In one or more embodiments, method 900 can proceed similar to blocks 810-820 of FIG. 8.

As can now be appreciated, disclosed embodiments can improve the digital wellbeing of young users of an electronic device by inhibiting usage of the device after a certain period of time. Situations where a primary user, such as a parent, temporarily provides an electronic device, such as a smartphone, to a secondary user, such as a child, can occur during daily life. Such situations can occur when parent(s) are busy working, cooking, eating or doing any tasks and decide to loan their phone to their children to keep them occupied during that time. In these situations, the disclosed embodiments improve the technical field of electronic communication devices by gradually guiding the secondary user to return the electronic device to the primary user rather than requiring the primary user having to request the secondary user stop using the device and return it to the primary user, eliminating or reducing feelings of angst or agitation by the secondary user.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a display;
a memory having stored thereon at least one application and a secondary user mode control module for controlling the electronic device; and
at least one processor communicatively coupled to the display and to the memory, the at least one processor executing program code of the control module, which enables the electronic device to:
enter a secondary user mode of operation; and
generate a quality-of-service parameter reduction for at least one quality-of-service (QoS) parameter in response to the electronic device being in the secondary user mode of operation for a predetermined duration.

2. The electronic device of claim 1, wherein to generate the QoS parameter reduction, the at least one processor reduces the at least one QoS parameter in increments.

3. The electronic device of claim 1, wherein to generate the QoS parameter reduction, the at least one processor reduces a QoS parameter selected from a group that comprises: a resolution of the display, a brightness of the display, and a size of a video window that is rendered on the display.

4. The electronic device of claim 1, wherein to generate the QoS parameter reduction, the at least one processor causes random pauses in playback of a video that is rendered on the display.

5. The electronic device of claim 1, further comprising:
a network interface communicatively coupled to the at least one processor and which enables the electronic device to connect to a network and download content being consumed at the electronic device; and
wherein to generate the QoS parameter reduction, the at least one processor induces an artificial network latency in the electronic device that negatively affects a consumption of the content.

6. The electronic device of claim 1, wherein the at least one processor:
monitors a time remaining for the secondary user mode of operation;
computes a false battery level (FBL), wherein the FBL is based on the time remaining and is less than an actual remaining battery level; and
displays the FBL in place of the actual remaining battery level.

7. The electronic device of claim 6, wherein the at least one processor initiates a false shutdown mode of the device, including deactivating the display and other interface features of the electronic device in response to at least one of (i) the time remaining reaching zero or (ii) the FBL reaching an empty charge value on the display.

8. The electronic device of claim 1, further comprising at least one biometric input mechanism, wherein the at least one processor:
monitors for entry of a biometric authentication input of a primary user; and
reactivates the display and returns the electronic device to a primary user mode of operation in response to a biometric authentication of the primary user while the electronic device is in one of a secondary user mode of operation or a false shutdown mode.

9. The electronic device of claim 1, further comprising:
a communication subsystem that enables the electronic device to communicate with at least one second device via an external network, the communication subsystem communicatively coupled to the at least one processor;
wherein the at least one application comprises a plurality of applications; and
wherein the at least one processor:
receives, via the communication subsystem, a ranking for each application of the plurality of applications that are executable on the electronic device; and
sets a QoS reduction duration (QRD) for each application of the plurality of applications, based on a respective ranking.

10. The electronic device of claim 1, wherein the at least one processor:
identifies, based on one or more inputs, a secondary user from among a plurality of secondary users that each have a corresponding secondary user profile and associated QoS parameter reduction; and
modifies at least one QoS reduction duration based on the identified secondary user.

11. A method comprising:
entering a secondary user mode of operation for an electronic device, wherein the electronic device comprises a display, a memory storing at least one application and a control module for controlling the electronic device, and at least one processor communicatively coupled to the display and to the memory; and
generating, by the at least one processor, a quality-of-service (QoS) parameter reduction for at least one quality-of-service (QoS) parameter in response to the electronic device being in the secondary user mode of operation for a predetermined duration.

12. The method of claim 11, wherein the generating comprises reducing the at least one QoS parameter in increments.

13. The method of claim 11, wherein the generating of the QoS parameter reduction comprises reducing a QoS parameter selected from a group that comprises: a resolution of the display, a brightness of the display, and a size of a video window that is rendered on the display.

14. The method of claim 11, wherein the generating of the QoS parameter reduction comprises causing random pauses in playback of a video that is rendered on the display.

15. The method of claim 11, wherein:
the electronic device further comprises a network interface communicatively coupled to the at least one processor and which enables the electronic device to connect to a network and download content being consumed at the electronic device; and
generating the QoS parameter reduction comprises inducing an artificial network latency that negatively affects a consumption of the content in the electronic device.

16. The method of claim 11, wherein:
the electronic device comprises at least one biometric input mechanism; and
the method further comprises:
monitoring for entry of a biometric authentication input of a primary user from the at least one biometric input mechanism; and
reactivating the display and returning the electronic device to a primary user mode of operation in response to a biometric authentication of the primary user.

17. The method of claim 11, further comprising:
monitoring a time remaining for the secondary user mode of operation;
computing a false battery level (FBL), wherein the FBL is based on the time remaining and is less than an actual remaining battery level; and
displaying the FBL in place of the actual remaining battery level.

18. The method of claim 17, further comprising deactivating the display and other interface features of the electronic device in response to the time remaining reaching zero.

19. The method of claim 11, wherein:
the at least one application comprises a plurality of applications; and
the method comprises:
receiving, via a communication subsystem, a ranking for each application of the plurality of applications that are executable on the electronic device; and
setting a QoS reduction duration (QRD) for each application of the plurality of applications, based on a respective ranking.

20. A computer program product comprising:
a non-transitory computer readable storage device having stored thereon program code which, when executed by at least one processor of an electronic device, enables the electronic device to provide functionality of:
entering a secondary user mode of operation for the electronic device; and
generating a quality-of-service (QOS) parameter reduction for at least one quality-of-service (QoS) parameter in response to the electronic device being in the secondary user mode of operation for a predetermined duration.
